(19) United States
(12) Patent Application Publication
(10) Pub. No.: US 2013/0126619 A1
(43) Pub. Date: May 23, 2013

(54) METHOD AND SYSTEM FOR CERTIFYING CONTACT INFORMATION

(71) Applicants: Emiliano Del Fiume, Rome (IT); Claudio Valentini, Rome (IT)

(72) Inventors: Emiliano Del Fiume, Rome (IT); Claudio Valentini, Rome (IT)

(73) Assignee: UNISYS CORPORATION, BLUE BELL, PA (US)

(21) Appl. No.: 13/299,369

(22) Filed: Nov. 18, 2011

(51) Int. Cl. G06K 19/06; G06K 19/07

(52) U.S. Cl. 235/492; 235/494

(57) ABSTRACT

A method and system for certifying contact information is described. The method includes embedding the contact information in a format and encoding the format into a matrix barcode. The encoded matrix barcode is digitally signed to certify the contact information. Further, the format includes a vCard format and the matrix barcode includes a quick response code.

### FIELD

This application deals generally with the field of matrix barcodes, and more specifically with sharing information using matrix barcodes.

### BACKGROUND

In the present day world, social networking is critical for establishing and maintaining relations between people who share interests or activities. People share their visiting cards or business cards during formal introductions as a convenience and a memory aid. These cards are usually printed on a card stock and are exchanged. Business cards are also available in electronic formats for sharing the cards using electronic devices. A business card typically includes a person's name, a company name, and contact information such as street addresses, telephone number(s), fax number, e-mail addresses and website. The business card can also include confidential data such as a person's bank account number, tax code and the like, which one may like to share only with a trustworthy person.

One has to maintain a card holder for storing the physical business cards of various persons one has met. One may also have to tirelessly flip through the leaflets of the card holder to locate the contact information of a person. Certain electronic business card solutions attempt to store and share the contact information electronically. However, at times, one may have to manually feed the business card information into one's electronic contact book leading to time wastage. In addition, a person can disguise herself as a different person by presenting or sharing the electronic business card of the other person. A recipient cannot judge and validate whether the business card reflects the true identity of the presenter of the electronic business card. Moreover, such systems fail to protect a person's profile information from reaching unauthorized, illegitimate or illicit destinations.

Confidentiality, integrity and timely availability of information are critical for maintaining effective relationships in the present fast-paced world. As a result, there exists a need for a technique to conveniently present and share contact information in a certified, standardized and compact format. In addition, there remains a need to restrict access to information from reaching unsafe, insecure, or unapproved destinations.

### SUMMARY

The present disclosure describes a system for certifying contact information. The system includes an embed unit for embedding the contact information in a format, and a coding unit for encoding the format into a matrix barcode. Moreover, a certification unit digitally signs the matrix barcode to certify the embedded contact information.

Another embodiment of the present disclosure describes a method for certifying contact information. The method includes embedding the contact information in a format and encoding the format into a matrix barcode. Further, the method includes certifying the contact information by digitally signing the matrix barcode.

These and other advantages, features, and objects of the claimed disclosure will become apparent upon review of the following detailed description of the preferred embodiments when taken in conjunction with the drawings and the appended claims.

### BRIEF DESCRIPTION OF THE DRAWINGS

The figures set out and illustrate a number of exemplary embodiments of the disclosure. Throughout the figures, like reference numerals refer to identical or functionally similar elements. The figures are illustrative in nature and are not drawn to scale.

FIG. 1 illustrates an exemplary system for certifying contact information.

FIG. 2 shows a matrix barcode affixed to a tangible medium, created according to one embodiment.

FIG. 3 is a block diagram illustrating an exemplary system for creating a digitally certified business card in matrix barcode format.

FIG. 4 is a flow chart illustrating an exemplary method for certifying contact information.

While various modifications and alternative forms of the disclosed system and method are contemplated, specific exemplary embodiments are disclosed in the drawings and are described in detail herein. It should be understood, however, that the drawings and detailed description are not intended to limit the scope of the claims contained herein to the particular form disclosed, but on the contrary, the disclosure is intended to cover all modifications, equivalents, and alternatives falling within the spirit and scope of the claimed invention as defined by the appended claims.

### DETAILED DESCRIPTION

The following detailed description is made with reference to the figures. Embodiments are described to illustrate the disclosed system and method, not to limit their scope. With the insight provided by the instant disclosure, those of ordinary skill in the art should recognize a variety of equivalent variations on the description that follows.

### Overview

Embodiments of the present disclosure are directed to methods and systems for encoding and certifying contact information. The present disclosure effectively uses a matrix barcode to embed contact information in a standardized format. The matrix barcode can be printed onto a business card, thus facilitating the transmission of the contact information from the business card to any device capable of reading the barcode. The capable device can directly import the information into the device's contacts list. Consequently, an exchange of contact information is simplified and speeds up. The method includes digitally signing the embedded information with industry-recognized certificates, such as the Unisys certificate, to avoid identity abuses, resulting in overall authentication of the information. To this end, the method effectively utilizes the standardized formats such as the vCard standard and the matrix barcodes such as the QR code to accomplish a variety of tasks, including, without limitation, standardized and compact presentation of contact information, and certification of identity information.

In today's fast-paced world, one should be able to conveniently share, as well as access, a person's authentic contact information in one's ever-expanding social circles. People do not have the time to input new business cards into their databases, and validate the information for potential identity abuse. Embodiments of the present disclosure reduce the complexity of manually feeding information to electronic business contact books, and improve the exchange of contact information. In addition, the methods and systems disclosed herein can be used to present and share contact information in a standardized and compact format, digitally signed with an authentication certificate.

It should be noted that the description below does not set out specific details of manufacture or design of the various components. Those of skill in the art are familiar with such details, and unless departures from those techniques are set out, techniques and designs known in the art should be employed, and those in the art are capable of choosing suitable manufacturing and design details.

### Description of Embodiments

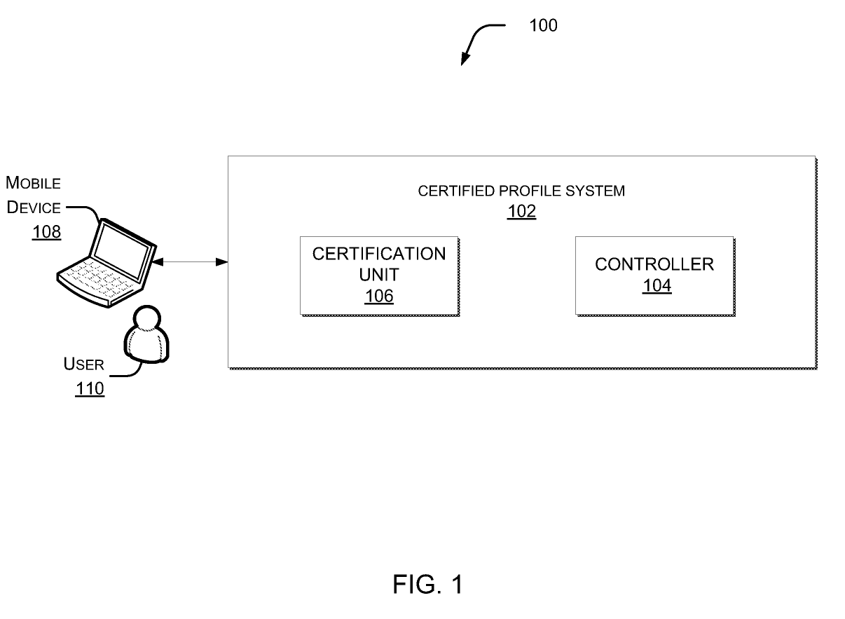

FIG. 1 illustrates an exemplary system 100 for certifying contact information. A certified profile system 102 is operatively connected to a mobile device 108. A user 110 may operate the mobile device 108 to generate information requests, share authentic information, and receive the requested information. The certified profile system 102 creates certified contact information using a certification unit 104 and a controller 106.

Consider a scenario in which the user 110 attends a business conference with entry allowed only to special invites. The user 110 requests the certified profile system 102 to create a digitally certified business card using the mobile device 108. The user 110 inputs the desired details (such as contact information) to the certified profile system 102. On receiving the request, the certified profile system 102 embeds the information in a standard format (such as the vCard) and encodes the formatted information into a matrix barcode. The certified profile system 102 also digitally signs the matrix barcode with the user's certificate, such as a Unisys certificate, to create a digitally certified business card. The user 110 can then use the certified business card to authenticate her entry to the business conference by presenting the card to a device capable of reading the card. During the business conference, the user 110 may wish to grow her professional network and establish relations with people who share interests or activities. The user 110 can present her certified business card to other conference invitees. Using a device capable of reading the card, other invitees can store the user's business card in their devices. The other invitees can validate that the business card reflects the true identity of the user 110 by decrypting the Unisys certificate. Similarly, the user 110 can store certified business cards of other invitees in her mobile device 108. The following disclosure illustrates a mechanism to present contact information in such a certified, standardized and compact manner.

The mobile device 108 is a computing device operated by the user 110 to request the certified profile system 102 to create digitally certified business cards. The mobile device 108 can read matrix barcodes, extract information from the matrix barcodes, and can store the extracted information. The user 110 can also retrieve the stored information for future use. The mobile device 108 may include, for example, a personal digital assistant, a computer (e.g., a laptop, a desktop workstation, a server, etc.), a cellular phone, a mobile internet device (MID), an ultra-mobile PC (UMPC) or any other device operable to communicate with the certified profile system 102. The mobile device 108 is capable of receiving an input, presenting an output on a display screen, performing suitable processing of the input or output or both, and communicating with other devices. The mobile device 108 is also capable of capturing a matrix barcode using a camera. Further, the communication capabilities of the mobile device 108 may include communicating through a LAN, a WAN, a wireless network such as Bluetooth, Wi-Fi, Wi-Max, or other communication system, allowing the mobile device 108 to communicate to other devices.

The certified profile system 102 creates a digitally certified business card, in a standardized format, presented in a matrix barcode using the controller 106 and the certification unit 104. The certified profile system 102 receives a request from the mobile device 108 for creating a certified business card. The request may include the user 110 information to be presented on the matrix barcode. Using the controller 106, the certified profile system 102 embeds the user 110 information in a standard format and encodes the formatted information into a matrix barcode. The certification unit 104 digitally signs the matrix barcode to certify the barcode and avoid potential identity abuse.

The controller 106 can be any suitable device capable of executing instructions and manipulating data to perform operations, and meeting the processing requirements of the certified profile system 102. Controller 106 may include microprocessors, microcomputers, microcontrollers, digital signal processors, central processing units, state machines, logic circuitries, and/or any devices that manipulate signals based on operational instructions. For example, controller 106 may be any central processing unit (CPU), such as such as the Pentium processor, the Intel Centrino processor, and the like.

A digital signature is an electronic signature that can be used to authenticate the identity of the message sender or the signer of a document. The digital signature ensures that the original information content is intact. Digital signatures are easily transportable, cannot be imitated by someone else, and can be automatically time-stamped.

A digital certificate, issued by a trustworthy authority such as the Unisys, contains a digital signature of the certificate-issuing authority to verify that the certificate is real. The digital certificate provides an indisputable binding of the entity (a user, an institution or a device) that holds the private key to its corresponding public key. On conveying the public key required for validating a digital signature, the digital certificate assures a receiving party of both the integrity and authenticity of the signed information.

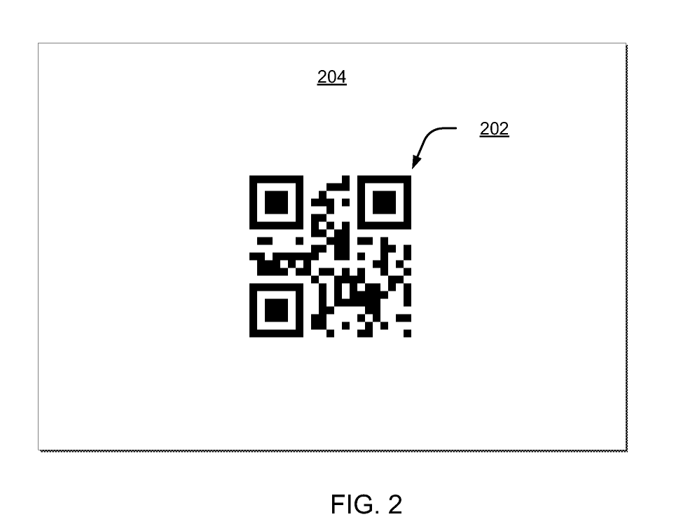

FIG. 2 shows a matrix barcode 202 affixed to a tangible medium 204, such as a piece of paper, a card stock, or the like. In one embodiment, the matrix barcode 202 is a quick response or QR code, and the tangible medium 204 is a card stock of a business card. The matrix barcode 202 may also be designed using other codes such as the Aztec code, the PDF417 code, the Data Matrix code, the MaxiCode, the SuperCode, the UltraCode, and the like. The QR code 202 may contain information such as a person's name, a company name, contact information such as street addresses, telephone number(s), fax number, e-mail addresses, and a web address, a person's bank account number, tax code and the like. The QR code 202 may also be displayed on other media, such as a web page, a magazine, a newspaper, a display screen (such as a mobile device) and the like. As the information is stored vertically as well as horizontally, the matrix barcodes have the ability to store large amounts of information.

As the matrix barcode 202 can store large amounts of information, the matrix barcode 202 can be used to convey detailed information about the person's profile and her contact information. In the example of FIG. 2, the QR code 202 may show and describe a person's work experience, professional and academic references, educational details, personal and professional achievements, certifications, industry recognitions, web address and the like. However, the information may be sent or received by an unauthorized person. To avoid potential identity abuse, the matrix barcode 202 is digitally signed with an industry-recognized certificate such as the Unisys certificate. The digitally signed matrix barcode 202 can be easily verified in cases of suspected forgery. A device, capable of reading the matrix barcode 202, may decode the information on the matrix barcode 202 and share the desired information with other users.

The tangible medium 204 may contain personal contact information in alphanumeric format graphically printed, and accompanied by the matrix barcode 202 that represents the contact information in a digital format. In an embodiment, the matrix barcode 202 containing contact information can be printed alone, or with partial alphanumeric data, on the tangible medium 204.

In an alternative embodiment, the tangible medium 204 may also include an electronic tag, such as a radio frequency identification device (RFID) tag, to wirelessly transmit the digitally signed matrix barcode 202. A wireless receiver with a capability to receive the electronic tag can be activated to access the digitally signed matrix barcode 202. The electronic tags can be read from a far off distance and beyond the line of sight of the receiver. Therefore, the tangible medium 204 can transfer the matrix barcode 202 to the receiver without showing the electronic tag. The electronic tag can be bulk read by multiple receivers simultaneously enabling sharing of information quickly.

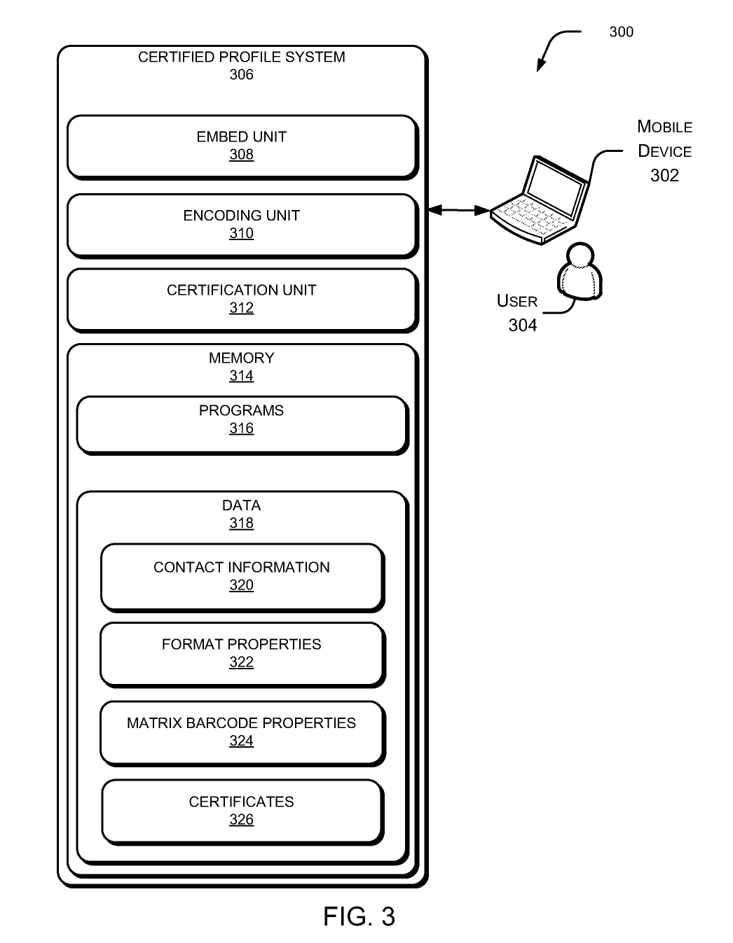

FIG. 3 illustrates an exemplary certified profile system 306 for creating a digitally certified business card in a matrix barcode format. Based on requests from a user 304, using a mobile device 302, the certified profile system 306 is capable of creating multiple business cards in matrix barcode format for different purposes. The certified profile system 306 includes an embed unit 308, an encoding unit 312, a certification unit 312 and a memory 314. The memory 314 is further divided into one or more program(s) 316 and data 318. The data 318 includes various data banks for storing different data. The programs 316 store various program modules designed to dynamically create matrix barcodes and present a desired matrix barcode based on various factors. The factors may include presence or absence of prior user settings, presence or absence of history settings, environment conditions or a combination of these.

The embed unit 308 embeds the contact information 320 in a standard format. The embed unit 308 fetches the contact information from the data bank contact information 320. The user 304 stores the contact information in the data bank 320 by manually feeding the information using the mobile device 302. A piece of information can also be fed and stored in the data bank 320 by using input devices associated with the mobile device 302, such as a camera, a keypad, a touch screen and the like. The embed unit 308 also fetches a standard format and its properties from the data bank format properties 322. The standard format may be a file format standard for electronic business cards such as the vCard. The contact information is embedded in the fetched standard, applying the properties of the standard format. As a result, the embed unit 308 creates a standard file, including the information of one or more persons, places, business firms, things, or the like. The file may have a filename extension such as .vcf, the commonly used filename extension for vCards. The embed unit 308 shares the standard file with the encoding unit 310 for further processing.

The data bank format properties 322 contain file format standards and their properties. The file format standard may be a standard for electronic business cards, such as the vCard standard version 4.0, vCard standard version 3.0, vCard standard version 2.1 and the like. A vCard may be attached to an e-mail message, or may also be exchanged on the World Wide Web or an instant messaging application. The vCard can contain name and address information, phone numbers, e-mail addresses, Unique Resource Locators, logos, photographs, audio clips and the like. The standard such as the vCard defines a number of properties. The properties may include a structured representation of the name of a person, place, or thing associated with the standard; an address for electronic mail communication with the standard; a global positioning property specifying latitude and longitude; a standard time zone and the like. The properties may also include a unique identifier specifying a value that represents a persistent, globally unique identifier; and a public encryption key associated with an object of the standard. For example, contact information may be structured according to digital vCard version 4.0 formats in XML style (namely xCard). The vCard version 4.0 includes, among others, an XML tag named “KEY” that contains the public encryption key for the vCard object, thus, resulting in an XML structure representation of the contact information. The properties, the unique identifier and the public encryption, enhance the standard to support the opportunity to digitally sign fields with an authentication certificate and avoid identity abuses.

The encoding unit 310 encodes the standard format file, received from the embed unit 308, into a matrix barcode. The encoding unit 310 receives the standard format file from the embed unit 308. In addition, a matrix barcode and its properties are fetched from the data bank matrix barcode properties 324. A particular matrix barcode may be fetched from the databank based on input from the mobile device 302 by the user 304. Fetching of barcode may also be based on prior user settings, history settings or a combination of these. The matrix barcode may be the Quick Response code consisting black modules arranged in a square pattern on a white background. Using an algorithm of the selected matrix barcode, the encoding unit 310 processes the standard file to form a matrix barcode. The algorithm may be stored in the programs 316. Depending on the selection of the matrix barcode, the algorithm may also be fetched from the matrix barcode properties 324.

For example, the encoding unit may fetch a QR code encoding algorithm from the matrix barcode properties 324. The encoding unit 310, utilizing the algorithm, may treat an eight-bit data as a code word and may create a four-bit long mode indicator. The mode indicator may signify the input data type, stored in the standard file, to be a numeric, an alphanumeric, a kanji, or a byte. A character count indicator may be appended to the mode indicator depending on the number of characters in the input data stream. The input data may be represented in binary form and added to the appended mode indicator. A terminator data bit may be added to the input data, thus creating a result dataset. The result dataset may be represented in decimal form and an error correcting code may be appended to the result dataset. The appended result dataset may be arranged in a matrix of rows and column following the rules of allocation of the QR code. The rules of allocation, and the error correcting code, may be stored in the matrix barcode properties 324. The matrix results in the creation of the matrix barcode. The encoding unit 310 shares the matrix barcode with the certification unit 312 for further processing.

The data bank matrix barcode properties 324 contain various types of matrix barcodes and their properties. The matrix barcode is a two-dimensional representation of information and may include codes such as the QR code, the Aztec code, the PDF417 code, the Data Matrix code, the MaxiCode, the SuperCode, the UltraCode and the like. The matrix barcode may contain information such as a person's name, a company name, contact information such as street addresses, telephone number(s), fax number, e-mail addresses, and a web address, a person's bank account number, tax code and the like. The matrix barcode may also be displayed on media, such as a cardstock, a web page, a magazine, a newspaper and the like. As the information is stored vertically as well as horizontally, the matrix barcodes have the ability to store large amounts of information. The large storage capability enables the matrix barcode to convey detailed information about a person's profile and her contact information. Other features offered by the matrix barcode may include: the barcode may be resistant to dirt, distortion, and damage; it may be read from any direction in 360 degrees; and the barcode may store data written in kanji and kana characters, allowing the barcode to store an extra 20% data. Multiple matrix barcodes may be appended to form a single matrix barcode. Conversely, a single matrix barcode may also be divided into multiple barcodes.

A QR code includes the following elements in its design: a finder pattern, a timing pattern, an alignment pattern, a quiet zone and cells. The finder pattern detects the position of the QR code. The QR code includes three finder patterns enabling the QR code's size and angle to be detected and read from any direction. The timing pattern identifies the central coordinate of data cells. With both horizontal and vertical layout, distorted and smudged data can be identified. When a QR code is warped, the alignment pattern corrects the distortion of the QR code. A black cell in the middle of the alignment pattern provides a central reference point for reading the code. The quiet zone is a contrasting margin space necessary for reading the QR code. The cells store the data as binary codes, with binary 0's and 1's translated into black or white cells. The QR codes also possess an error correction level, preventing an incorrect data read. The levels signify the maximum percentage of errors, present in the QR code, which can be corrected. A detailed specification of the QR code is documented in the international standard ISO/IEC 18004.

The certification unit 312 digitally signs the matrix barcode received from the encoding unit 310. The certification unit 312 receives the matrix barcode, containing the contact information, from the encoding unit 310. A hash value of the matrix barcode is computed and encrypted with a private key, resulting in a digital signature. The certification unit 312 fetches a certificate from the data bank certificates 326. The certificate includes a public key required for signature validation and authentication of the contact information. A particular certificate may be fetched from the databank based on input from the mobile device 302 by the user 304. Fetching of a certificate may also be based on prior user settings, history settings or a combination of these. On fetching, the certification unit 312 binds the fetched certificate and the digital signature. The bind certificate is packaged with the received matrix barcode. Thus, a digitally signed matrix barcode, containing the contact information with the certificate, is created.

The data bank certificates 326 contain private keys, public keys and digital certificates. Each private key has a corresponding public key to lead to a hash value for signature validation. A second public key required for signature validation is included in and protected by a digital certificate. A party receiving the digitally signed matrix barcode may validate the digital signature by re-computing the hash value, decrypting the signature using the corresponding public key and comparing the results. Any alteration to the original content of the matrix barcode causes the comparison to fail.

The memory section programs 316 store various modules to assist the embed unit 308, the encoding unit 310, and the certification unit 312. Using the programs modules, the certified profile system 306 can dynamically create various matrix barcodes. The programs 316 may store the algorithms of different matrix barcodes to encode the standard file of the contact information into a desired matrix barcode.

In an alternative embodiment, the certified profile system 306 may also include an electronic tag such as a radio frequency identification device (RFID) tag to wirelessly transmit the digitally signed matrix barcode. A wireless receiver with a capability to receive the electronic tag can be activated to access the digitally signed matrix barcode. The electronic tags can be read from a far off distance and beyond the line of sight of the receiver. Therefore, the certified profile system 306 can transfer the matrix barcode to the receiver without showing the electronic tag. The electronic tag can be bulk read by multiple receivers simultaneously enabling sharing of information quickly.

### Exemplary Methods

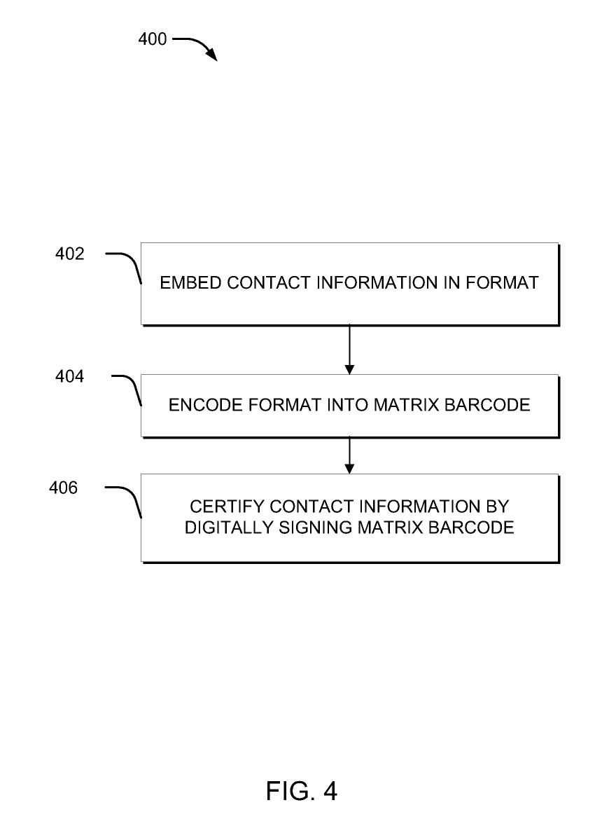

FIG. 4 illustrates an exemplary method 400 for encoding and certifying contact information. The method 400 may be implemented on the system 100 shown in the FIG. 1, among other devices. In the embodiments of the present disclosure, some of the method elements shown may be performed concurrently, in a different order than shown, or may be omitted. Additional method elements may be performed as desired.

At block 402, the embed unit 308 embeds the contact information 320 in a standard format. The contact information is fetched from the data bank contact information 320. The user 110 may store the information, using the mobile device 302, to the data bank 320 or may directly feed the information to the embed unit 308. The user 110 may also feed and store the information in the data bank 320 by using input devices associated with the mobile device 108, such as a camera, a keypad, a touch screen and the like. On fetching the contact information 320, the embed unit 308 also fetches a standard format and its properties from the data bank format properties 322. The standard format may be a file format standard for electronic business cards such as the vCard. The embed unit 308 embeds the contact information in the fetched standard, applying the properties of the standard format. As a result, a standard file is created, containing the information of one or more persons, places, business firms, things or the like. The file may have a filename extension such as .vcf, the commonly used filename extension for vCards. The embed unit 308 shares the standard file with the encoding unit 310 for further processing.

At block 404, the encoding unit 310 encodes the standard format file, received from the embed unit 308, into a matrix barcode. The encoding unit 310 receives the standard format file from the embed unit 308, and fetches a matrix barcode and its properties from the data bank matrix barcode properties 324. A user 110 may direct the encoding unit 310 to fetch a particular matrix barcode based on her requirements. Fetching of barcode may also be based on prior user settings, history settings or a combination of these. The matrix barcode may be the Quick Response code, the Aztec code, the PDF417 code, the Data Matrix code, the MaxiCode, the SuperCode, the UltraCode and the like. Using an algorithm of the selected matrix barcode, the encoding unit 310 processes the standard file to form a matrix barcode containing the contact information. The encoding unit 310 may fetch the algorithm from the programs 316. Depending on the selection of the matrix barcode, the encoding unit 310 may also fetch the algorithm from the matrix barcode properties 324.

In an implementation, the encoding unit 310 may fetch a QR code encoding algorithm from the matrix barcode properties 324. The encoding unit 310, utilizing the algorithm, may treat an eight-bit data as a code word and may create a four-bit long mode indicator. The mode indicator may signify the input data type, stored in the standard file, to be a numeric, an alphanumeric, a kanji, or a byte. In addition, the encoding unit 310 may append a character count indicator to the mode indicator depending on the number of characters in the input data stream. The input data may be represented in binary form and added to the appended mode indicator. Moreover, the encoding unit 310 may append a terminator data bit to the input data, thus creating a result dataset. The result dataset may be represented in decimal form and an error correcting code may be appended to the result dataset. Further, the appended result dataset may be arranged in a matrix of rows and column following the rules of allocation of the QR code. The encoding unit 310 may fetch the rules of allocation and the error correcting code from the matrix barcode properties 324. The matrix, hence, results in the creation of the matrix barcode. The encoding unit 310 shares the matrix barcode with the certification unit 312 for further processing.

Next, at block 406, the certification unit 312 digitally signs the matrix barcode received from the encoding unit 310. The certification unit 312 receives the matrix barcode, containing the contact information, from the encoding unit 310. On receiving, the certification unit 312 computes a hash value of the matrix barcode and encrypts the barcode with a private key, resulting in a digital signature. Each private key has a corresponding public key to lead to a hash value for signature validation. In addition, the certification unit 312 may fetch a certificate from the data bank certificates 326. The certificate includes a public key required for signature validation and authentication of the contact information. A user 110, using the mobile device 108, may direct the certification unit 312 to fetch a particular certificate from the databank based on her requirements. Fetching of a certificate may also be based on prior user settings, history settings or a combination of these. On fetching, the certification unit 312 binds the fetched certificate and the digital signature. The bind certificate is packaged with the received matrix barcode. Thus, a digitally signed matrix barcode, containing the contact information, with the certificate is created.

The exemplary method 400 may be described in the general context of computer executable instructions. Generally, computer executable instructions can include routines, programs, objects, and the like, to perform particular functions or to implement particular abstract data types. The method 400 may also be practiced in a distributed computing environment where functions are performed by remote processing devices linked through a communications network. In that environment, computer executable instructions may be located in both local and remote computer storage media, including memory storage devices.

In an alternative embodiment, the method 400 may also wirelessly transmit the digitally signed matrix barcode by an electronic tag, such as a radio frequency identification device (RFID) tag. A wireless receiver with a capability to receive the electronic tag can be activated to access the digitally signed matrix barcode. The electronic tags can be read from a far off distance and beyond the line of sight of the receiver. Therefore, the matrix barcode can be read by the receiver without showing the electronic tag.

Using the system and methods disclosed herein, the certified profile system 102 creates certified contact information presented in a standardized and compact manner. In other embodiments, the certified profile system 102 may receive a certified matrix barcode, containing the contact information of an entity. On receiving, the certified profile system 102 may decode the certified matrix barcode. Further, the certified profile system 102 may extract the digital signature of the matrix barcode and decrypt the signature using a public key. The certified profile system 102 may validate the digital signature by computing a hash value. A second hash value is also computed from the contact information embedded in the matrix barcode. The certified profile system 102 may compare the hash values received from different operations. If the hash values match, the signature is validated. Any alteration to the original content of the matrix barcode causes the comparison to fail. On a validated signature, the certified profile system 102 extracts and presents the contact information to the user 110. The contact information may be imported to an address list, an email application, or the like.

The specification has set out a number of specific exemplary embodiments, but persons of skill in the art will understand that variations in these embodiments will naturally occur in the course of embodying the subject matter of the disclosure in specific implementations and environments. It will further be understood that such variations and others as well, fall within the scope of the disclosure. Neither those possible variations nor the specific examples set above are set out to limit the scope of the disclosure. Rather, the scope of claimed invention is defined solely by the claims set out below.

What is claimed is:

1) A system for certifying contact information, the system comprising:
an embed unit for embedding the contact information in a format;
a coding unit for encoding the format into a matrix barcode; and
a certification unit for digitally signing the matrix barcode.

2) The system of claim 1, wherein the format includes a vCard format.

3) The system of claim 1, wherein the matrix barcode includes a quick response code.

4) The system of claim 1, wherein the certification unit binds a certificate to the matrix barcode.

5) The system of claim 4, wherein the certificate includes a Unisys certificate.

6) The system of claim 1, wherein the digitally signed matrix barcode is presented on a tangible medium.

7) The system of claim 6, wherein the tangible medium includes at least one of:
a paper, a card stock, a display screen, or a web page.

8) The system of claim 1, further comprising an electronic tag to wirelessly transmit the digitally signed matrix barcode

9) The system of claim 8, wherein the electronic tag includes a RFID tag.

10) A method for certifying contact information, the method comprising:
embedding the contact information in a format;
encoding the format into a matrix barcode; and
certifying the contact information by digitally signing the matrix barcode.

11) The method of claim 10, wherein the format includes a vCard format

12) The method of claim 10, wherein the matrix barcode includes a quick response code.

13) The method of claim 10, further comprising binding a certificate to the matrix barcode.

14) The method of claim 11, wherein the certificate includes a Unisys certificate.

15) The method of claim 10, further comprising presenting the digitally signed matrix barcode on a tangible medium.

16) The method of claim 15, wherein the tangible medium includes at least one of:
a paper, a card stock, a display screen, or a web page.

17) The method of claim 10, further comprising wirelessly transmitting the digitally signed matrix barcode by an electronic tag.

18) The method of claim 17, wherein the electronic tag includes a RFID tag.

19) A business card for sharing contact information, the business card comprising:
a matrix barcode embedded with contact information,
wherein the contact information is presented in a vCard format; and
the matrix barcode is certified by a digital signature.

20) The business card of claim 19, wherein the matrix barcode includes a quick response code.

21) The business card of claim 19, further comprising an RFID tag to wirelessly transmit the digitally signed matrix barcode.
